(19) United States
(12) Patent Application Publication
(10) Pub. No.: US 2013/0071162 A1
(43) Pub. Date: Mar. 21, 2013

(54) COLOR TONER FOR OPTICAL FIXING AND IMAGE FORMING APPARATUS

(71) Applicant: Tomohiro MAEDA, Osaka-shi (JP)

(72) Inventor: Tomohiro MAEDA, Osaka-shi (JP)

(21) Appl. No.: 13/562,593

(22) Filed: Jul. 31, 2012

(30) Foreign Application Priority Data
Sep. 20, 2011 (JP) 2011-204838

(51) Int. Cl. G03G 15/20; G03G 9/00

(52) U.S. Cl. 399/336; 430/105; 430/108.2

(57) ABSTRACT

A color toner for optical fixing containing an infrared light absorbent and being compatible with an optical fusing device to irradiate an unfixed toner attached on a surface of a recording medium with infrared light to melt and fix the unfixed toner on the recording medium, wherein

an optical absorptance of the color toner is set to be lower than an optical absorptance of a black toner in a wavelength region of the infrared light emitted from the optical fusing device.

### CROSS-REFERENCE TO RELATED APPLICATIONS

This application is related to Japanese Patent application No. 2011-204838, filed on 20 Sep. 2011 whose priority is claimed under 35 USC §119, the disclosure of which is incorporated by reference in its entirety.

### BACKGROUND OF THE INVENTION

1. Field of the Invention

The present invention relates to a color toner for optical fixing and an image forming apparatus capable of using the same.

2. Description of the Related Art

An electrophotographic type image forming apparatus such as a copy machine, a printer, or a facsimile machine is provided with a fusing device to thermo-melt a toner image formed on a recording paper to fix on the paper. As one example of the fusing device, a roller pair type fusing device provided with a fuser roller, a pressure roller, and a temperature control device is well-known (refer to Japanese Unexamined Patent Publication No. 11-38802).

Each of the fuser roller and the pressure roller is a roller member having a metal (such as aluminum) hollow cored bar, and a heat resistant elastic layer (such as silicon rubber layer) formed on a surface of the cored bar.

A halogen lamp is arranged inside the cored bar of the fuser roller as a heat source. In addition, a temperature sensor is provided on a surface of the fuser roller, and the temperature control device controls the ON/OFF of the halogen lamp based on a signal outputted from the temperature sensor, so that a temperature of the fuser roller surface is controlled.

The pressure roller is pressed against a peripheral surface of the fuser roller and a nip region is formed between the fuser roller and the pressure roller due to elastic deformation of the elastic layer of the pressure roller.

According to the fusing device having the above configuration, when a recording paper having an unfixed toner image passes through the nip region between the rotating fuser roller and the pressure roller, the toner image on the paper is melted by heat of the peripheral surface of the fuser roller and fixed on the paper.

However, according to the image forming apparatus provided with this roller pair type fusing device, after turned off and left overnight, the fuser roller and the pressure roller have a room temperature, so that a warm-up time is needed until the fuser roller and the pressure roller reaches a predetermined temperature, even after they are turned on at the start of an operation. In addition, even in a stand-by state in which a copy action is not performed, the surface of the fuser roller needs to be at the predetermined temperature, so that the surface has to be constantly heated even when the copy action is not performed. Thus, energy is wasted while the copy action is not performed.

Thus, as a method for fixing only the toner efficiently without wasting energy, a laser fusing device to melt and fix a toner on the recording paper with infrared laser light is proposed (refer to Japanese Unexamined Patent Publication No. 2005-55516).

According to this laser fusing device, even when a fixing property is insufficient only with one weak infrared laser light, it is considered that the fixing property is improved by heating the toner with several number of pieces of infrared laser light. In addition, since the low-power and inexpensive semiconductor laser can be used, the apparatus can be simple as a whole.

In the case where the color toner is fixed on the recording paper with the laser fusing device, since a normal color toner hardly absorbs light in a wavelength region (around 780 nm) of the infrared laser light, an infrared light absorbent is added to the color toner in order to ensure an absorption region corresponding to that laser wavelength. In addition, in a case of a black toner, since carbon black serving as a colorant absorbs the infrared laser light, the infrared light absorbent is not added to the black toner.

A full-color image formed on the recording paper has a part of one fixed color layer (one layer), a part of two fixed color layers (two layers), and a part of three fixed color layers (three layers), among a cyan toner, a magenta toner, and a yellow toner. When the unfixed toner is fixed on the recording paper by the optical fusing device, a surface layer of the toner layer is irradiated with the infrared laser light, heat is transferred from the surface layer to a lower layer, and the lower layer is melted, whereby the toner layer is fixed on the recording paper.

However, when the plurality of toner layers are provided, the surface layer absorbs the largest amount of the infrared laser light, and the absorption amount of the infrared laser light is reduced towards the lower layer. That is, the surface layer of the toner layer is rapidly heated and melted, but the infrared laser light is not likely to reach the lower layer, so that by the time the lower layer is melted by the heat from the surface layer, the surface layer is heated too much and thermally decomposed, and as a result, the toner color is changed.

Therefore, a process speed is reduced to prevent the color change and to ensure the fixing property, but another problem arises such that productivity is decreased when the process speed is reduced.

### SUMMARY OF THE INVENTION

The present invention was made in view of the above problems, and it is an object of the present invention to provide a color toner for optical fixing in which a color change of a toner surface is prevented and a fixing property thereof is ensured without reducing a process speed, and an image forming apparatus capable of using the above toner.

Thus, a color toner for optical fixing according to the present invention contains an infrared light absorbent and is compatible with an optical fusing device to irradiate an unfixed toner attached on a surface of a recording medium with infrared light to melt and fix the unfixed toner on the recording medium, in which an optical absorptance of the color toner is set to be lower than an optical absorptance of a black toner in a wavelength region of the infrared light emitted from the optical fusing device.

In addition, an image forming apparatus according to another aspect of the present invention includes a photoconductor drum having a surface on which an electrostatic latent image is formed, a charging device charging a surface of the photoconductor drum, an exposure device forming an electrostatic latent image on the surface of the photoconductor drum, a developing device having capacity to accommodate the color toner for optical fixing, and a black toner, and supplying the toner to the electrostatic latent image on the surface of the photoconductor drum to form a toner image, a transferring device transferring the toner image on the surface of the photoconductor drum to a recording medium, and an optical fusing device irradiating the toner image transferred to the recording medium with infrared light.

According to the color toner for optical fixing in the present invention, the optical absorptance of the color toner is set to be lower than the optical absorptance of the black toner in the wavelength region of the infrared light emitted from the optical fusing device. That is, based on the optical absorptance of the black toner, the optical absorptance of the color toner is set to be lower than the reference value.

Thus, in a case where a monochromatic image and a full-color image are formed on the recording medium by the image forming apparatus provided with the optical fusing device, when the black toner layer is fixed, the one layer can be efficiently fixed, and when the three color toner layers are fixed, the color toner layers can be efficiently fixed by melting the lower layer while preventing a color of the surface layer from being changed because the infrared light is likely to reach the lower layer.

In addition, the image forming apparatus using the color toner for optical fixing in the present invention can efficiently fix the color toner layer on the recording medium while preventing the color of the surface layer from being changed at the time of forming the image. In addition, since the toner image is fixed on the recording medium by the optical fusing device, compared with the roller pair type fusing device, a warm-up time of the image forming apparatus can be shortened, and a power is not consumed at the time of a stand-by period, so that power consumption can be considerably reduced.

### BRIEF DESCRIPTION OF THE DRAWINGS

FIG. 1 is a schematic front view showing a dry electrophotographic type color image forming apparatus provided with a fixing type color toner according to a first embodiment of the present invention.

FIG. 2 is a schematic front view showing a fusing device in the image forming apparatus according to the first embodiment.

FIG. 3 is a schematic right-side view showing the fusing device in the image forming apparatus according to the first embodiment.

### DETAILED DESCRIPTION OF THE PREFERRED EMBODIMENTS

A color toner for optical fixing according to the present invention contains an infrared light absorbent, and is compatible with an optical fusing device which irradiates an unfixed toner attached on a surface of a recording medium with infrared light to melt and fix the unfixed toner on the recording medium, and it is characterized in that an optical absorptance of the color toner is set to be lower than an optical absorptance of a black toner in a wavelength region of the infrared light emitted from the optical fusing device.

Hereinafter, when the “optical absorptance” is simply used, it means the optical absorptance of the toner in the wavelength region of the infrared light.

In the case of the black toner, its colorant (representative of carbon black) absorbs the infrared light with a wavelength of about 780 nm, but a general colorant used in a color toner (cyan toner, magenta toner, or yellow toner) as will be described below hardly absorbs the infrared light, so that a predetermined amount of infrared light absorbent is contained through the color toner for optical fixing of each color in the present invention. This predetermined amount is set such that the optical absorptance of the color toner is lower than the optical absorptance of the black toner in the wavelength region of the infrared light emitted from the optical fusing device. Thus, a color toner layer can be efficiently fixed while preventing a color of a surface layer from being changed.

Here, according to the present invention, the “optical absorptance of the color toner” is defined by a value which is measured in a following way.

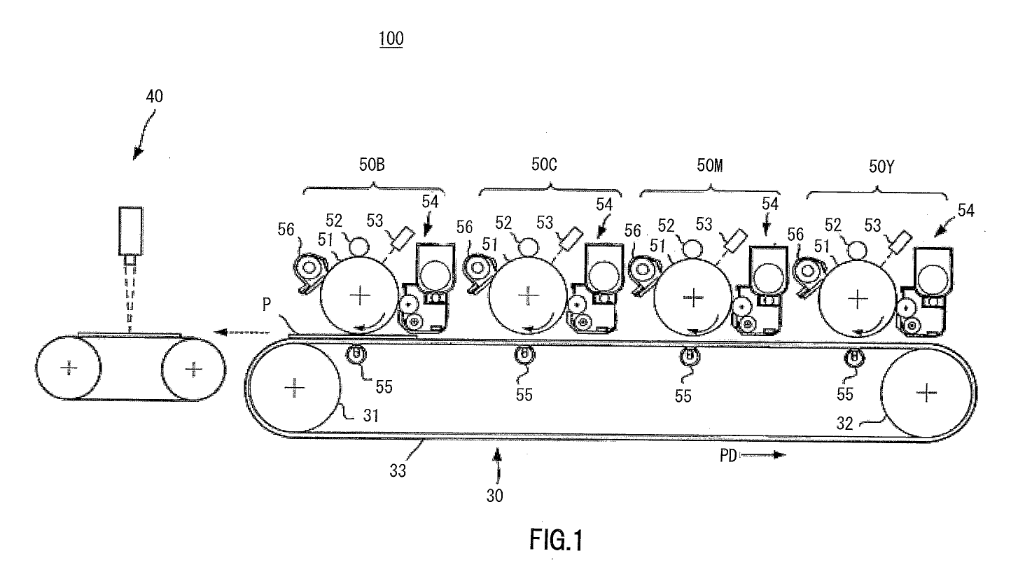

With an image forming apparatus shown in FIGS. 1 to 3 as will be described below, an unfixed solid image of a toner is formed on a white recording paper by a toner weight (attached amount) of 0.4 mg/cm² per unit area, and in order to measure absorption characteristics of a sample at a laser wavelength of 780 nm, a reflectance of the sample is measured with a spectrophotometer U-3300 (produced by Hitachi, Ltd.). At this time, the sample is made with respect to each of the color toners (cyan toner, magenta toner, and yellow toner) and the black toner, and its reflectance is measured by irradiating the sample with the infrared laser light with the wavelength of 780 nm. Thus, the optical absorptance of the color toner provided based on the optical absorptance of the black toner is represented by λ3 obtained such that λ3=[(100−λ2)/(100−λ1)]×100 wherein λ1 represents the reflectance of the sample of the black toner, and λ2 represents the reflectance of the sample of the color toner. The λ3 is a value smaller than 100 in the present invention.

The reason why a ratio of the reflectance λ2 of the color toner to the reflectance λ1 of the black toner is set as the optical absorptance λ3 of the color toner is that an absolute value of the reflectance differs depending on the toner attached amount, so that when the sample of each color is compared under the condition of the same attached amount based on the black toner, a relative value becomes almost the same, so that the ratio of the reflectance can be expressed as the optical absorptance of the color toner with respect to the black toner.

According to the color toner for optical fixing in the present invention, the optical absorptance of the color toner is set to be lower than that an optical absorptance of the black toner, and the optical absorptance of the color toner is preferably set to be 50 to 90% of the optical absorptance of the black toner.

As the optical absorptance of the color toner is set to be 50 to 90% of the optical absorptance of the black toner, in a case where three laminated color toner layers are fixed, a temperature difference between a surface layer and a lower layer becomes optimal, so that the color toner layer can be more efficiently fixed.

In order to efficiently heat the color toner for optical fixing in the present invention at the time of fixing, the infrared light absorbent is enclosed with a resin particles serving as a component material of the color toner. That is, the infrared light absorbent is internally added to the color toner, and the infrared light absorbent is covered with the resin particles, so that the infrared absorbent which has absorbed the infrared light can diffuse heat in all directions. As a result, the color toner can be efficiently heated and melted. Meanwhile, in a case where the infrared light absorbent is externally added to the color toner, the infrared light absorbent is attached on an outer surface of the resin particle, even when its optical absorptance is the same as that of the color toner internally containing the infrared light absorbent. Thus, the heat of the infrared light absorbent which has absorbed the infrared light can be transmitted from a contact part to the resin particle, but it is likely to escape from a non-contact part to the atmosphere.

The infrared light absorbent used in the color toner for optical fixing in the present invention includes, but not limited to, a cyanine compound. The cyanine compound is a superior infrared light absorbent because it has a maximum absorption peak within a wavelength range of 780 to 1000 nm, and has a high optical absorption coefficient (more than 10⁵), so that it is high in absorption efficiency of the infrared laser light. Therefore, when the cyanine compound is used for the infrared light absorbent, a sufficiently fixing property can be provided even when an additive amount of the infrared light absorbent is small.

Hereinafter, a detailed description will be given of embodiments of the color toner for optical fixing and the image forming apparatus according to the present invention with reference to the drawings. In addition, in this specification and the drawings, as for a component having substantially the same function, it is marked with the same reference and its duplicative description is omitted.

### First Embodiment

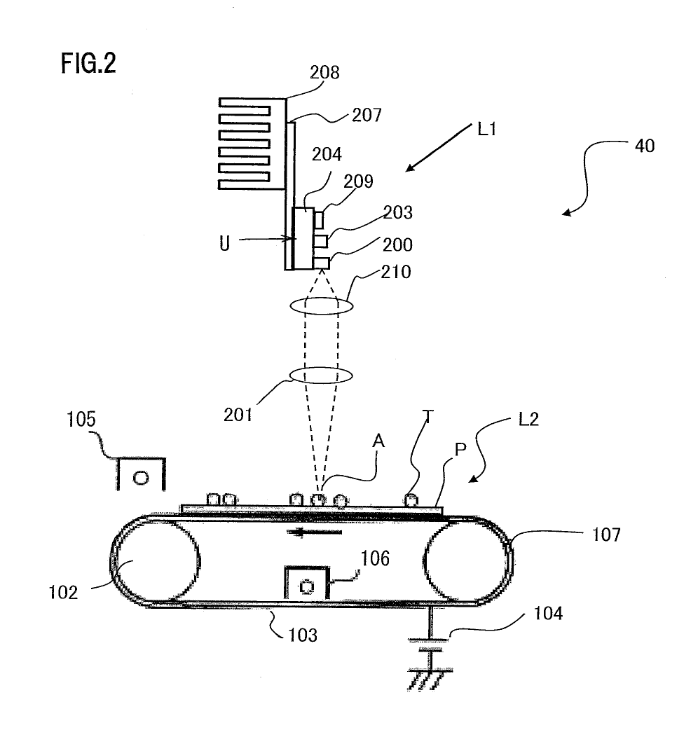

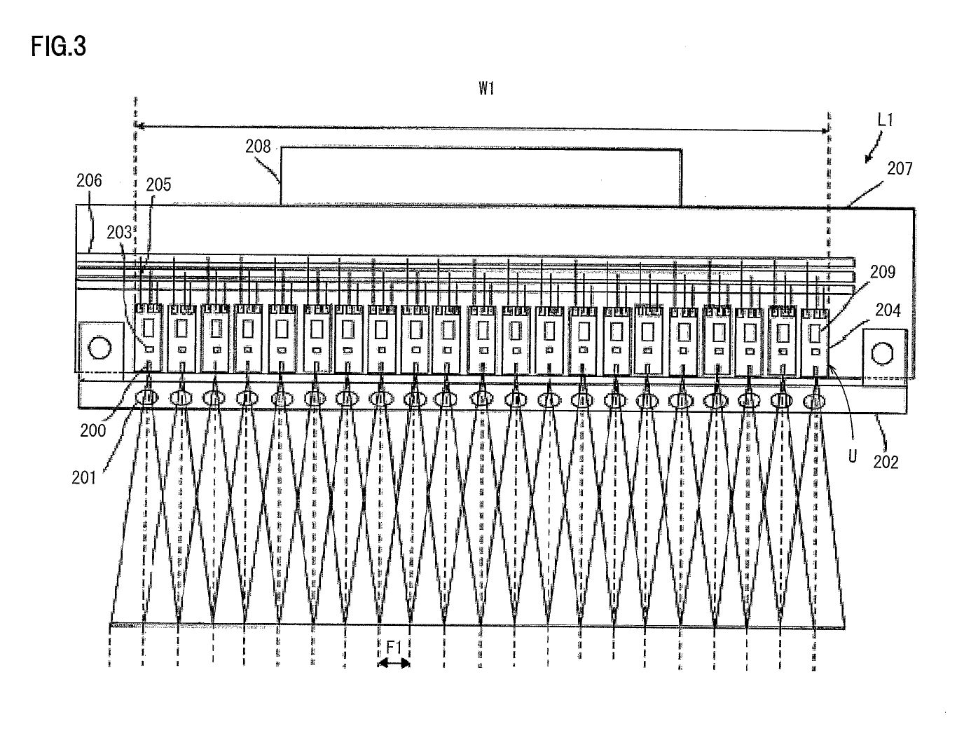

FIG. 1 is a schematic front view of a dry electrophotographic color image forming apparatus provided with a fixing type color toner according to a first embodiment of the present invention, FIG. 2 is a schematic front view showing a fusing device in the image forming apparatus according to the first embodiment, and FIG. 3 is a schematic right-side view showing the fusing device in the image forming apparatus according to the first embodiment.

### <Image Forming Apparatus>

As shown in FIG. 1, an image forming apparatus 100 which can use the color toner for optical fixing in the present invention forms a multicolor or unicolor toner image on a sheet serving as a recording medium, based on image data transmitted from each terminal device on a network, and includes four visible image forming units 50Y, 50M, 50C, and 50B, a sheet conveying apparatus 30, and a fusing device 40.

The four visible image forming units 50Y, 50M, 50C, and 50B correspond to yellow (Y), magenta (M), cyan (C), and black (B), respectively, and arranged in a tandem manner along the sheet conveying apparatus 30. That is, the visible image forming unit 50Y forms an image using a toner of yellow (Y), the visible image forming unit 50M forms an image using a toner of magenta (M), the visible image forming unit 50C forms an image using a toner of cyan (C), and the visible image forming unit 50B forms an image using a toner of black (B). Since the visible image forming units 50Y, 50M, 50C and 50B all have substantially the same configuration, they are collectively represented by a reference numeral 50 in some cases below.

The visible image forming unit 50 includes a photoconductor drum 51, a charger 52, a laser light irradiation section 53 to form a latent image on the photoconductor drum 51, a developing device 54, a transfer roller 55, and a cleaner unit 56. The visible image forming unit 50 transfers the toner image of each color of yellow, magenta, cyan, and black in this order on a sheet P conveyed by the sheet conveying apparatus 30 in a laminating manner.

The photoconductor drum 51 carries the formed toner image. The charger 52 uniformly charges a surface of the photoconductor drum 51 to a predetermined potential. The laser light irradiation unit 53 exposes the surface of the photoconductor drum 51 charged by the charger 52 and forms an electrostatic latent image on the surface of the photoconductor drum 51, based on image data inputted to the image forming apparatus. The developing device 54 visualizes the electrostatic latent image formed on the surface of the photoconductor drum 51 with the toner of each color.

A method for developing the electrostatic latent image includes a one-component developing method using a magnetic one component developer or non-magnetic one component developer, and a two-component developing method using two component developers containing a toner and a carrier, and both of the developing methods can be used for the color toner for optical fixing in the present invention.

According to the two-component developing method, magnetic particles called the carrier and the toner are agitated to be frictionally charged in the developing device, and the toner is carried on a surface of the carrier. Thus, a developing process is performed such that the carrier (developer) carrying the toner forms a magnetic brush on a surface of a developing roller enclosing a magnet member, and the toner in the magnetic brush is transferred from the developing roller to an electrostatic latent image on the photoconductor drum. According to the two-component developing method, an apparatus configuration becomes complicated a little compared with the one-component developing method, but a potential of the toner can be relatively easily set, and high-speed responsiveness and stability can be provided, so that the two-component developing method is widely used, and also employed in this embodiment.

As for the transfer roller 55, a bias having a polarity opposite to a polarity of the toner is applied thereto, and the transfer roller 55 transfers the toner image formed on the photoconductor drum 51 to the sheet P conveyed by the sheet conveying apparatus 30.

The drum cleaner unit 56 removes and collets the toner left on the surface of the photoconductor drum 51 after the toner image formed on the photoconductor drum 51 has been transferred to the sheet P.

The sheet conveying apparatus 30 has a drive roller 31, an idling roller 32, and a conveying belt 33, and conveys the sheet P to be located below the visible image forming units 50 so that the toner image of each color can be formed on the sheet P by the visible image forming unit 50.

The drive roller 31 and the idling roller 32 strain the endless conveying belt 33, and when the drive roller 31 is controlled and rotated at a predetermined peripheral velocity, the endless conveying belt 33 is rotated in a direction of an arrow PD. The conveying belt 33 generates static electricity on an outer surface, and conveys the sheet P while electrostatically absorbing the sheet P.

The toner image is transferred on the sheep P while the sheet P is conveyed by the conveying belt 33. Thereafter, the sheet P is removed from the conveying belt 33 due to a curvature of the drive roller 31, and conveyed to the fusing device 40.

As shown in FIG. 2, the fusing device 40 includes a light irradiation section L1, and a sheet conveying section L2. The fusing device 40 in this embodiment applies heat to the unfixed toner image formed on the surface of the sheet P (recording medium) to fix the unfixed toner image onto the sheet P.

More specifically, the sheet P carrying the unfixed toner image is conveyed at a predetermined speed to a light irradiation area A on the sheet conveying section L2, and the toner is heated and melted by the heat of the infrared light emitted from the light irradiation section L1 and fixed onto the sheet P.

The sheet conveying section L2 includes a drive roller 102, a driven roller 107, a motor (not shown) to rotate the drive roller 102, a power supply 104 to supply a power to the motor, a separation charger 105, a discharging charger 106, a conveying belt 103, and a control section (not shown).

The conveying belt 103 is an endless belt stretched by the drive roller 102 and the driven roller 107, and includes a material provided by diffusing conductive particles such as carbon into a resin such as polycarbonate, vinylidene fluoride, or polyimide. In addition, the conveying belt 103 is rotated by the drive roller 102 with the electrostatic absorption force weakened. Since the conveying belt 103 has a large curvature, a tip end of the sheet P is removed from the conveying belt 103, and the sheet P is completely isolated from the conveying belt 103 by an isolation claw (not shown).

The motor is controlled by a signal from the control section. By this control, a sheet conveying speed of the conveying belt 103 is changed, and arbitrarily adjusted depending on various kinds of conditions. For example, in this embodiment, the sheet conveying speed is set to 22 cm/sec.

A light source of the light irradiation section L1 to emit the infrared light includes a flashlamp, LED, and laser, and among these, the laser is preferably used because light diffusion is small, and the infrared laser light can be concentrated in conjunction with a collecting lens and efficiently emitted. Furthermore, in the case of the laser irradiation, only a position of the toner can be selectively heated, so that the toner can be efficiently heated. In addition, the laser includes a semiconductor laser, CO₂ laser, and YAG laser, and among them, when the semiconductor laser is used, the light irradiation section L1 can be produced at low cost.

As shown in FIGS. 2 and 3, the light irradiation section L1 in this embodiment has a ceramic substrate 207, a plurality of light irradiation units U provided on one surface of the ceramic substrate 207, and a radiator plate (heatsink) 208 provided on the other surface opposite to the one surface of the ceramic substrate 207.

The light irradiation unit U has a silicon substrate 204, a semiconductor laser element 200 serving as a light source provided on the silicon substrate 204, a photodiode 203, a laser control circuit (not shown) integrally formed with the photodiode 203, and a temperature sensor 209 (thermistor).

In addition, the light irradiation section L1 has a collimator lens 210 and a condenser lens 201 which correspond to each light irradiation unit U, and has a wire bonding line 205 and a surface electrode 206 provided on the ceramic substrate 207.

In the light irradiation section L1 in this embodiment, the plurality of semiconductor laser elements 200 are arranged in a line along a width direction of the conveying belt 103 (direction perpendicular to the sheet conveying direction), and serve as a semiconductor laser element array. A length W1 of the semiconductor laser element array is roughly the same as a width of the conveying belt 103, and may be 250 to 350 mm. In addition, a distance F1 between the adjacent semiconductor laser elements 200 is 0.1 to 10 mm.

The laser control circuit may be configured to change an output of a light amount of the semiconductor laser element 200, based on a temperature signal detected by the temperature sensor 209.

The semiconductor laser element 200 and the silicon substrate 204 are electrically connected by the wire bonding line 205.

In addition, an electrode (not shown) of the silicon substrate 204 and the surface electrode 206 of the ceramic substrate 207 are electrically connected by a wire bonding.

The infrared laser light emitted from the semiconductor laser element 200 passes through the corresponding collimator lens 210 and the condenser lens 201, and is applied on the sheet P on the laser irradiation area A. Each semiconductor laser element emits the laser light, while focusing on the unfixed toner image on the sheet P, but at this time, the laser light is only focused on in a sheet conveying direction, and spreads in a direction perpendicular to the conveying direction so that the adjacent laser lights are overlapped.

After the toner image is fixed in the laser irradiation area A, the sheet P is conveyed, with electrostatically absorbed by the conveying belt 103, to a part between the separation charger 105 and the drive roller 102. The drive roller 102 includes a conductive material, and is grounded. Therefore, the isolation charger 105 discharges the sheet P, and weakens the electrostatic absorption force between the conveying belt 103 and the sheet P.

### <Color Toner for Optical Fixing>

The color toner for optical fixing in the present invention includes a yellow toner for optical fixing, a magenta toner for optical fixing, and a cyan toner for optical fixing. Hereinafter, a description will be given of raw materials including a binder resin, a colorant, and an infrared light absorbent in the color toner for optical fixing.

### (1-1) Binder Resin

The binder resin includes, but not limited to, a polyester based resin, styrene based resin such as polystyrene and styrene-acrylic acid ester copolymer resin, acrylic based resin such as polymethylmethacrylate (hereinafter, referred to as PMMA), polyolefin based resin such as polyethylene, polyurethane, epoxy resin, and silicone resin.

### (1-2) Colorant

As the colorant, a dye and a pigment of each color (yellow, magenta, or cyan) may be used.

The yellow toner colorant includes an organic pigment such as C.I. pigment yellow 1, C.I. pigment yellow 5, C.I. pigment yellow 12, C.I. pigment yellow 15, C.I. pigment yellow 17, C.I. pigment yellow 74, C.I. pigment yellow 93, C.I. pigment yellow 180, and C.I. pigment yellow 185; an inorganic pigment such as yellow iron oxide and yellow ocher; nitro based dye such as acid yellow 1; and an oil-soluble dye such as C.I. solvent yellow 2, C.I. solvent yellow 6, C.I. solvent yellow 14, C.I. solvent yellow 15, C.I. solvent yellow 19, and C.I. solvent yellow 21 which are classified by a color index.

The magenta toner colorant includes C.I. pigment red 49, C.I. pigment red 57, C.I. pigment red 81, C.I. pigment red 122, C.I. solvent red 19, C.I. solvent red 49, C.I. solvent red 52, C.I. basic red 10, and C.I. disperse red 15 which are classified by a color index.

The cyan toner colorant includes C.I. pigment blue 15, C.I. pigment blue 16, C.I. solvent blue 55, C.I. solvent blue 70, C.I. direct blue 25, and C.I. direct blue 86 which are classified by a color index.

In the color toner for optical fixing in the present invention also, a red pigment and a green pigment may be used other than the above colorant.

In addition, as for the color toner for optical fixing in the present invention, the above colorant may be used alone, or two or more different colorants (such as colorants of similar colors) may be combined so as to attain a desired color.

In addition, as for the color toner for optical fixing in the present invention, it is preferable to use the pigment which is superior in heat resistance, light resistance, and chromogenic property, compared with the dye.

As for the color toner for optical fixing in the present invention, the colorant is preferably used as a masterbatch. The masterbatch of the colorant can be produced by kneading a melted material of the resin and the colorant.

The binder resin used in the masterbatch is preferably a resin of the same kind as the binder resin used in the color toner particles, or a resin having a preferable compatibility with the binder resin.

A mixture ratio between the binder resin and the colorant in the masterbatch preferably includes, but not limited to, 30 to 100 parts by weight of colorant with respect to 100 parts by weight of resin.

A particle diameter of the masterbatch is preferably granulated to be 2 to 3 mm in diameter and used, but not limited thereto.

A ratio of the masterbatch in the color toner, and a ratio of the colorant in the masterbatch preferably includes, but not limited to, 17.3 to 40 parts by weight of masterbatch with respect to 100 parts by weight of color toner, and 4 to 20 parts by weight of colorant (80 to 96 parts by weight of binder resin) with respect to 100 parts by weight of masterbatch, respectively. Thus, a filler effect due to addition of the colorant is suppressed, and a color toner having high coloring power can be obtained. In addition, when the color toner contains more than 20 parts by weight of colorant, a fixing property of the color toner could be lowered due to the filler effect of the colorant.

The colorant of the black toner which serves as a reference toner in setting the optical absorptance of the color toner for optical fixing in the present invention includes carbon black such as channel black, roller black, disc black, gas furnace black, oil furnace black, thermal black, and acetylene black.

The black toner can be produced similarly to the color toner for optical fixing in the present invention except that the infrared light absorbent is not added.

### (1-3) Infrared Light Absorbent

The infrared light absorbent preferably has, but not limited to, a maximum absorption wavelength λmax within a wavelength range of 780 to 1000 nm. That is, the infrared light absorbent preferably absorbs the visible light as little as possible to suppress an effect on a color phase of the color toner. Here, the “infrared light” means an electromagnetic wave with a wavelength of 780 to 10⁶ nm (1 mm), and the “visible light” means an electromagnetic wave with a wavelength of 380 to less than 780 nm.

The infrared light absorbent which can be used in the color toner for optical fixing in the present invention includes a cyanine compound, diimonium compound, aluminum compound, polymethine compound, and phtalocyanine compound, and the one compound may be used alone, or two or more compounds may be combined and used.

The cyanine compound includes KAYASORB CY-40MC (product name, produced by NIPPON KAYAKU CO., LTD.), KAYASORB CYP-4646 (F) (product name, produced by NIPPON KAYAKU CO., LTD.), NK-4680 (product name, produced by Hayashibara Co., LTD.), and SD50-E05N (product name, produced by Sumitomo Seika Chemicals Company, Limited).

The diimonium compound includes CIR-1085 (product name, produced by Japan Carlit Co., Ltd.), and CIR 1085F (product name, produced by Japan Carlit Co., Ltd.).

The aluminum compound includes NIR-AM1 (product name, produced by Nagase ChemteX Corporation).

The polymethine compound includes IRT (product name, produced by Showa Denko K.K.).

The phthalocyanine compound includes IR-10A (product name, produced by NIPPON SHOKUBAI CO., LTD.), and IR-12 (product name, produced by NIPPON SHOKUBAI CO., LTD.).

Among the various kinds of infrared light absorbents, the cyanine compound is preferable for the infrared light absorbent used in the color toner for optical fixing in the present invention. The cyanine compound has an absorption peak of the electromagnetic wave within a wavelength range of 780 to 1000 nm, and has high degree of light absorption, so that the cyanine compound can sufficiently improve the efficiency of the infrared light absorption in the color toner. Thus, the color toner shows a sufficient fixing property at the time of fixing with the infrared light.

An infrared light absorbent content in the color toner for optical fixing in the present invention is to be set such that the optical absorptance of the color toner is lower than the optical absorptance of the black toner in the wavelength region of the infrared light emitted from the optical fusing device, and more specifically, the optical absorptance of the color toner is preferably set to be 50 to 90% of the optical absorptance of the black toner. In addition to this setting, the content may be adjusted based on the light absorption characteristics of the infrared light absorbent to be used, as a matter of course.

When the cyanine compound is used as the infrared light absorbent, the color toner for optical fixing in the present invention preferably contains 0.5 to 1 part by weight of cyanine compound with respect to 100 parts by weight of toner.

### (1-4) Others

The color toner for optical fixing in the present invention may contain an internal additive agent such as a wax or charge control agent when needed. Furthermore, the color toner for optical fixing in the present invention may contain an external additive agent such as a fluid additive.

### (I) Wax

A wax for the toner spreads on the recording medium with the binder resin in fixing the toner onto the recording medium and this is added to improve the fixing property of the toner.

A wax used in the color toner for optical fixing in the present invention includes, but not limited to, the normally used one in this field. For example, the wax includes a petroleum wax such as paraffin wax and its derivative, and microcrystalline wax and its derivative; hydrocarbon based synthetic wax such as Fischer Tropsch wax and its derivative, polyolefin wax and its derivative, low-molecular polypropylene wax and its derivative, and polyolefin based polymer wax and its derivative; carnauba wax and its derivative, and ester based wax.

The wax may be used alone, or two or more waxes may be combined.

A used amount of the wax preferably includes, but not limited to, 0.2 to 30 parts by weight of wax with respect to 100 parts by weight of binder resin (including the binder resin in the masterbatch) in the toner. When the content exceeds 20 parts by weight of wax with respect to 100 parts by weight of binder resin, a thin toner layer could be melted onto the photoconductor drum (filming), or a cracked toner particle could be attached on a carrier surface (spent). In addition, when the content is less than 0.2 part by weight of wax with respect to 100 parts by weight of binder resin, the wax could not achieve its function.

A melting point of the wax is not limited in particular, but when the melting point of the wax is too high, the effect of improving the fixing property of the toner due to the addition of the wax cannot be obtained. In addition, when the melting point of the wax is too low, a preserving property of the toner deteriorates. Therefore, the melting point of the wax is preferably 30 to 120° C.

In addition, the melting point of the wax can be found as a temperature of an apex of an endothermic peak of a DSC curve corresponding to a meltdown, with a differential scanning calorimeter (product name: DSC220 produced by SEIKO electronics industrial Co., Ltd.). More specifically, 1 g of a sample of the wax is heated up from 20° C. to 200° C. at a temperature increase rate of 10° C. per minute, then it is abruptly cooled down from 200° C. to 20° C., those operations are repeated two times, and the DSC curve is measured. The apex of the endothermic peak corresponding to the meltdown in the DSC curve measured after the second operation can be found as the melting point of the wax.

### (II) Charge Control Agent

A charge control agent for the toner is added to apply a preferable charging property to the toner. As the charge control agent used for the color toner for optical fixing in the present invention, but not limited to, the conventionally well-known charge control agent for a positive charge or a negative charge can be used.

The charge control agent for the positive charge includes a nigrosine dye, basic dye, quaternary ammonium salt, quaternary phosphonium salt, aminopyrine, pyrimidine compound, polynuclear polyamino compound, aminosilane, nigrosine dye and its derivative, triphenylmethane derivative, guanidine salt, and amidine salt.

The charge control agent for the negative charge includes an oil-soluble dye such as oil black or spirone black; metallized azo compound, azo complex dye, naphthenic acid metal salt, metal complex and metal salt (metal is chrome, zinc, or zirconium) of salicylic acid and its derivative, boron compound, fatty acid soap, long-chain alkyl carboxylic acid, and resin acid soap.

As for the charge control agent for the positive charge, one kind may be used alone, or two or more kinds of charge control agents for the positive charge may be combined. Similarly, as for the charge control agent for the negative charge, one king may be used alone, or two or more kinds of charge control agents for the negative charge may be combined.

In a case where the charge control agent having compatibility is used, a content of the compatible charge control agent is preferably 0.5 to 5 parts by weight with respect to 100 parts by weight of binder resin, and it is more preferably 0.5 to 3 parts by weight. When the content of compatible charge control agent is more than 5 parts by weight, the carrier is contaminated, and the toner is likely to scatter. In addition, when the content of the compatible charge control agent is less than 0.5 part by weight, sufficient charging characteristics cannot be applied to the toner.

### (III) Fluid Additive

The fluid additive for the toner includes inorganic fine particles of silica, titanium oxide, alumina, barium titanate, magnesium titanate, calcium titanate, strontium titanate, zinc oxide, tin oxide, silica sand, clay, mica, wollastonite, diatomite, chrome oxide, cerium oxide, colcothar, antimony trioxide, magnesium oxide, zirconium oxide, barium sulfate, barium carbonate, calcium carbonate, silicon carbonate, or carbon nitride. A primary particle diameter of the inorganic particle is preferably 5 μm to 2 μm, and especially preferably 5 μm to 500 μm. In addition, a specific surface area by a BET method is preferably 20 to 500 m²/g.

A surface preparation is performed for the fluid additive to improve hydrophobicity, so that flow characteristics and charging characteristics can be prevented from deteriorating even under high humidity. A preferable surface preparation agent includes a silane coupling agent, silylation agent, silane coupling agent having alkyl fluoride group, organic titanate based coupling agent, aluminum based coupling agent, silicone oil, and modified silicone oil.

### <Method for Producing Color Toner for Optical Fixing>

A method for producing the color toner for optical fixing in the present invention includes, but not limited to, a well-known method such as a dry process method or wet process method may be used. The dry process method includes a melting-kneading-grinding method.

The melting-kneading-grinding method includes a mixing step of mixing toner raw materials containing the binder resin, the masterbatch, the infrared light absorbent, the charge control agent, and the wax by a dry process, a melting and kneading step of melting and kneading a mixed material obtained in the mixing step, a cooling step of cooling and solidifying a melted and kneaded material obtained in the melting and kneading step, a grinding step of mechanically grinding a solidified material obtained in the cooling step, and a classifying step of removing a ground toner particle except for the one having a desired size, and the infrared light absorbent is internally added by a process for mixing the infrared light absorbent with other toner raw materials in the mixing step. That is, the infrared light absorbent is partially or wholly enclosed with the resin.

A mixer used in the dry process in the mixing step includes, but not limited to, a well-known mixer including Henschel type mixing apparatus such as Henschel mixer (product name, produced by Mitsui Mining Co., Ltd.), Super mixer (product name, produced by KAWATA MFG Co., Ltd.), or Mechanomill (product name, produced by OKADA SEIKO Co., Ltd.), Angmill (product name, produced by Hosokawa Micron Corp.), Hybridization system (product name, produced by NARA MACHINERY Co., Ltd.), and Cosmo system (product name, produced by Kawasaki Heavy Industries Ltd.).

In the melting and kneading step, the mixed material obtained in the mixing step is heated to a temperature of a melting point of the binder resin or higher while being stirred and kneaded. Here, the “temperature of a melting point of the binder resin or higher” is 80 to 200° C. in general, and preferably 100 to 150° C.

A kneading machine used in the melting and kneading step includes, but not limited to, a general kneading machine such as two-shaft extruder, triple roll mill, or Laboplasto mill. More specifically, the kneading machine includes a one-shaft or two-shaft extruder such as TEM-100B (product name, produced by Toshiba Machine Co., Ltd.), or PCM65/87 (product name, produced by IKEGAI Corp), and an open roll type kneading machine such as Kneadex (product name, produced by Mitsui Mining Co., Ltd.)

In the grinding step, the solidified material obtained after the melted and kneaded material has been cooled is ground by a grinding mill such as cutter mill, feather mill, or jet mill. The grinding mill may be used alone or two or more mills may be combined. For example, the solidified material may be coarsely ground by the cutter mill, and then ground by the jet mill, so that a core particle having a desired volume average particle diameter can be obtained.

In the classifying step, the coarse powder obtained through the grinding step is classified such that an over-ground toner is removed by a classifier, and a color toner particle having a desired volume average particle diameter can be obtained. The classifier includes a commercially-available rotary type classifier such as TSP separator (product name, produced by Hosokawa Micron Corp.)

Then, an external additive agent is added (externally added) to the color toner obtained in the classifying step. At this time, the color toner and the external additive agent are mixed by the Henschel mixer, and the external additive agent is attached on the color toner.

The external additive agent preferably includes a fluid additive containing the above inorganic fine particles and is used to improve the fluidity and charging property.

### Working Example

### Working Example 1

### Production of Samples 1 to 5, Comparison Sample A, and Reference Sample

Samples 1 to 5, and a comparison sample A were made by producing several kinds of color toners for optical fixing (volume average particle diameter: 6.7 μm) having different contents of the infrared light absorbent by the above melting-kneading-grinding method, and a reference sample was made by producing a black toner (volume average particle diameter: 6.7 μm) by the melting-kneading-grinding method. In addition, each sample was made for three colors (three kinds) of yellow, magenta, and cyan.

<Raw Materials of Color Toners for Optical Fixing (Samples 1 to 5, and Comparison Sample A) and their Ratio>
Binder resin: polyolefin based resin, 45.8% by weight (sample 1), 45.6% by weight (sample 2), 45.4% by weight (sample 3), 45.1% by weight (sample 4), 44.1% by weight (sample 5), 43.1% by weight (comparison sample A)
Masterbatch:

Masterbatch yellow: 31.5% by weight (polyolefin resin: 25.2% by weight, C.I. pigment yellow 74: 6.3% by weight)

Masterbatch magenta: 31.5% by weight (polyolefin resin: 25.2% by weight, C.I. pigment red 57: 6.3% by weight)

Masterbatch cyan: 31.5% by weight (polyolefin resin: 25.2% by weight, C.I. pigment blue 15: 6.3% by weight)
Infrared light absorbent: cyanine compound (product name NK-4680 produced by Hayashibara Co., Ltd.), 0.3% by weight (sample 1), 0.5% by weight (sample 2), 0.7% by weight (sample 3), 1.0% by weight (sample 4), 2.0% by weight (sample 5), 3.0% by weight (comparison sample A)
Charge control agent: boron compound, 0.9% by weight
Wax: ester based wax, 20% by weight
Fluid additive: silica, 1.5% by weight
   <Raw Materials of Black Toner (Reference Sample) and their Ratio>

Binder resin: polyolefin based resin, 70.1% by weight

Colorant: carbon black (product name Nipex-60 produced by

Degussa Japan Co., Ltd.), 7.5% by weight

Charge control agent: boron compound, 0.9% by weight

Wax: ester based wax, 20% by weight

Fluidizer: silica, 1.5% by weight

### [Measurement of Optical Absorptance]

With the image forming apparatus shown in FIGS. 1 to 3, the samples 1 to 5, the comparison sample A, and the reference sample, an unfixed solid image of a toner was made on a white recording paper by a toner weight (attached amount) of 0.4 mg/cm² per unit area. In order to measure absorption characteristics of each sample in a laser wavelength of 780 nm, reflectance of each sample was measured with a spectrophotometer U-3300 (produced by Hitachi, Ltd.). At this time, the reflectance was measured by irradiating the sample with the infrared laser light with the wavelength of 780 nm. Thus, the optical absorptance of each of the samples 1 to 5 (color toner) and the comparison sample A (color toner) provided based on the optical absorptance of the reference sample (black toner) was represented by λ3 obtained such that λ3=[(100−λ2)/(100−λ1)]×100 wherein λ1 represents the reflectance of the reference sample, and λ2 represents the reflectance of each of the samples 1 to 5, and the comparison sample A. A result is shown in Table 1.

TABLE 1

| | SAMPLE | | | | | | |
|---|---|---|---|---|---|---|---|
| | | | | | | COMPARISON | |
| | 1 | 2 | 3 | 4 | 5 | A | REFERENCE |
| INFRARED LIGHT ABSORBENT | 0.3 | 0.5 | 0.7 | 1.0 | 2.0 | 3.0 | — |
| CONTENT (% BY WEIGHT) | | | | | | | |
| REFLECTANCE λ2 (%) | 65 | 54 | 25 | 17 | 10 | 8 | 8 (λ1) |
| OPTICAL ABSORPTANCE | 38 | 50 | 82 | 90 | 98 | 100 | 100 |
| λ3 (%) | | | | | | | |

### [Fixing Property Test]

With the image forming apparatus (product name: MX-6201N produced by Sharp Corporation) provided with the optical fusing device 40 shown in FIGS. 2 and 3, a fixing property test was performed for the color toners of the samples 1 to 5. In addition, similar to the samples 1 to 5, and the comparison sample A, the fixing property test was performed for the black toner serving as the reference sample. In addition, each toner was set in each developing device of the image forming apparatus together with the carrier to be used as the two component developers (toner concentration is set to 8%).

### <Test Method>

With the image forming apparatus (product name: MX-6201N produced by Sharp Corporation) provided with the optical fusing device 40 shown in FIGS. 2 and 3, the color toners of the samples 1 to 5, and the comparison sample A (each sample is for three colors of yellow, magenta, and cyan), a solid image was formed on an A4-size recording paper (basis weight of 64 g/m²), under the condition that an attached amount is differently set and under the condition that an optical output of the light irradiation section is differently set. Here, the “basis weight” means a unit representing mass of the paper, and is expressed by mass (g) per square meter of the paper whose humidity is conditioned for four hours or more at 20° C. and 65% RH.

Then, a white paper was put on the produced toner image surface after the fixing process, a weight (a load of 10 cm×10 cm and 1 kgf) was put thereon, an end of the white paper was slowly pulled up by a hand while the toner image (recording sheet) was fixed, and it was confirmed whether or not the color toner is attached on the while paper after removed from the toner image. When the toner was not attached, the color toner was determined that the fixing property was good (O), and when the toner was attached thereon, it was determined that a fixing defect (A) was generated. Meanwhile, when the color toner was removed from the recording sheet at a touch of the toner image with a finger, it was determined that the fixing was undone (x), and the result was shown in Table 2.

### <Toner Attached Amount>

One color layer (cyan): 0.4 mg/cm²

Three color laminated layers (yellow, magenta, and cyan): 1.2 mg/cm²

### <Fixing Condition by Optical Fusing Device>

Light output of light irradiation section: 0.45 to 1.14 J/cm²

Laser collecting size (width of the light irradiation area A shown in FIG. 2 in a sheet conveying direction): 0.006 cm

Sheet conveying speed (process speed): 22 cm/sec

TABLE 2

| | | ATTACHED AMOUNT 0.4 mg/cm² (ONE LAYER) | | | | | | |
|---|---|---|---|---|---|---|---|---|
| | | BLACK | COLOR | | | | | |
| | | REFERENCE | SAMPLE | SAMPLE | SAMPLE | SAMPLE | SAMPLE | COMPARISON |
| | | SAMPLE | 1 | 2 | 3 | 4 | 5 | SAMPLE A |
| OPTICAL ABSORPTANCE λ3 (%) | | 100 (λ1) | 38 | 50 | 82 | 90 | 98 | 100 |
| LIGHT | 0.45 | Δ | x | x | Δ | Δ | Δ | Δ |
| OUTPUT | 0.51 | Δ | x | x | Δ | Δ | Δ | Δ |
| J/cm² | 0.57 | ∘ | x | Δ | ∘ | ∘ | ∘ | ∘ |
| | 0.63 | ∘ | ∘ | ∘ | ∘ | ∘ | ∘ | ∘ |
| | 0.68 | ∘ | ∘ | ∘ | ∘ | ∘ | ∘ | ∘ |
| | 0.80 | ∘ | ∘ | ∘ | ∘ | ∘ | ∘ | ∘ |
| | 0.91 | ∘ | ∘ | ∘ | ∘ | ∘ | ∘ | ∘ |
| | 1.02 | ∘ | ∘ | ∘ | ∘ | ∘ | ∘ | ∘ |
| | 1.14 | ∘ | ∘ | ∘ | ∘ | ∘ | ∘ | ∘ |
| | | | ATTACHED AMOUNT 1.2 mg/cm² (THREE LAMINATED LAYERS) | | | | | |
| | | | COLOR | | | | | |
| | | | SAMPLE | SAMPLE | SAMPLE | SAMPLE | SAMPLE | COMPARISON |
| | | | 1 | 2 | 3 | 4 | 5 | SAMPLE A |
| OPTICAL ABSORPTANCE λ3 (%) | | | 38 | 50 | 82 | 90 | 98 | 100 |
| | LIGHT | 0.45 | x | x | x | x | x | x |
| | OUTPUT | 0.51 | x | x | x | x | x | x |
| | J/cm² | 0.57 | x | x | x | x | x | x |
| | | 0.63 | x | x | x | x | x | x |
| | | 0.68 | x | Δ | Δ | Δ | x | x |
| | | 0.80 | Δ | ∘ | ∘ | ∘ | Δ | Δ |
| | | 0.91 | Δ | ∘ | ∘ | ∘ | Δ | Δ |
| | | 1.02 | ∘ | ∘ | ∘ | ∘ | ∘ | ∘ |
| | | 1.14 | ∘ | ∘ | ∘ | ∘ | ∘ | ∘ |

From the result shown in Table 2, it was confirmed that in both cases of the one color toner layer and the three color toner layers, by increasing the light output to some extent, a preferable fixing property can be obtained in each of the samples 1 to 5, and the comparison sample A in which the cyanine compound is used as the infrared light absorbent, and the optical absorptance of the color toner is set to be lower than or equal to the optical absorptance of the black toner.

More specifically, as for the black toner (optical absorptance is 100%) serving as the reference sample, it was confirmed that the black toner can be preferably fixed under the condition that the light output is 0.57 to 1.14 J/cm².

In addition, as for the one color toner layer, it was confirmed that the samples 3 to 5, and the comparison sample A (optical absorptance is 82 to 100%) can be preferably fixed under the condition that the light output is 0.57 to 1.14 J/cm², and the samples 1 to 5, and the comparison sample A (optical absorptance is 38 to 100%) can be preferably fixed under the condition that the light output is 0.63 to 1.14 J/cm².

Meanwhile, as for the three color toner layers, it was confirmed that the samples 2 to 4 (optical absorptance is 50 to 90%) can be preferably fixed under the condition that the light output is 0.80 to 1.14 J/cm², and the samples 1 to 5, and the comparison sample A (optical absorptance is 38 to 100%) can be preferably fixed under the condition that the light output is 1.02 to 1.14 J/cm².

However, as for the one color toner layer and the three color toner layers in the sample 5 containing 2% by weight of infrared light absorbent, and the comparison sample A containing 4% by weight thereof, even when the fixing property is good (O), irregularities like foam are recognized on the toner surface under the condition of 1.02 to 1.14 J/cm². It is considered that this was caused because the toner surface temperature becomes too high and thermal decomposition is generated.

In addition, although a test for a case of the two color toner layers is omitted in the working example 1, the result of the two color toner layers is considered to exist between the result of the one color toner layer and the result of the three color toner layers.

Thus, from the result of the working example 1, it was found that as the common conditions to obtain the preferable fixing property and toner surface in the case of the one to three color toner layers, and to obtain the preferable fixing property in the case of the black toner, the samples 2 to 4 in which the optical absorptance is set to 50 to 90% are to be used, and the light output is to be set to 0.80 to 1.14 J/cm².

Furthermore, a cost of the color toner is decreased with the less the content of the infrared light absorbent, and the energy is decreased with the smaller the light output, so that a preferable condition may be set in view of this. For example, in the case of the working example 1, the optical absorptance is set to 50, and the light output is set to 0.80 J/cm².

In addition, in the present invention, in a case where a monochrome mode to print a monochromatic image and a color mode to print a color image can be switched and selected in the image forming apparatus, a light output of the optical fusing device in the monochrome mode may be smaller than that in the color mode. For example, the light output may be controlled so as to be lowered from 0.80 J/cm² to 0.57 J/cm².

### Working Example 2

### Production of Samples 6 to 10, and Comparison Sample B

As samples 6 to 10, and a comparison sample B, several kinds of color toners for optical fixing having a different kind of the infrared light absorbent are produced, based on the raw materials of the working example 1 by the melting-kneading-grinding method, similar to the working example 1.

<Raw Materials of Color Toners for Optical Fixing (Samples 6 to 10, and Comparison Sample B) and their Ratio>
Binder resin: polyolefin based resin, 45.5% by weight (sample 6), 45.1% by weight (sample 7), 44.7% by weight (sample 8), 44.1% by weight (sample 9), 42.1% by weight (sample 10), 40.1% by weight (comparison sample B)
Masterbatch:

Masterbatch yellow: 31.5% by weight (polyolefin resin: 25.2% by weight, C.I. pigment yellow 74: 6.3% by weight)

Masterbatch magenta: 31.5% by weight (polyolefin resin: 25.2% by weight, C.I. pigment red 57: 6.3% by weight)

Masterbatch cyan: 31.5% by weight (polyolefin resin: 25.2% by weight, C.I. pigment blue 15: 6.3% by weight)
Infrared light absorbent: phthalocyanine compound (product name IR-12 produced by NIPPON SHOKUBAI Co., Ltd.), 0.6% by weight (sample 6), 1.0% by weight (sample 7), 1.4% by weight (sample 8), 2.0% by weight (sample 9), 4.0% by weight (sample 10), 6.0% by weight (comparison sample B)
Charge control agent: boron compound, 0.9% by weight
Wax: ester based wax, 20% by weight
Fluid additive: silica, 1.5% by weight

### [Measurement of Optical Absorptance]

With the image forming apparatus shown in FIGS. 1 to 3, the samples 6 to 10, the comparison sample B, and the reference sample in the working example 1, the optical absorptance was measured by the same method as that of the working example 1, and its result is shown in Table 3.

TABLE 3

| | SAMPLE | | | | | | |
|---|---|---|---|---|---|---|---|
| | | | | | | COMPARISON | |
| | 1 | 2 | 3 | 4 | 5 | B | REFERENCE |
| INFRARED LIGHT ABSORBENT | 0.6 | 1.0 | 1.4 | 2.0 | 4.0 | 6.0 | — |
| CONTENT (% BY WEIGHT) | | | | | | | |
| REFLECTANCE λ2 (%) | 65 | 54 | 25 | 17 | 10 | 8 | 8 (λ1) |
| OPTICAL ABSORPTANCE | 38 | 50 | 82 | 90 | 98 | 100 | 100 |
| λ3 (%) | | | | | | | |

### [Fixing Property Test]

A fixing property test was performed for the color toners of the samples 6 to 10, and the comparison sample B by the same test condition and test method as those of the working example 1. Its result is shown in Table 4.

TABLE 4

| | | ATTACHED AMOUNT 0.4 mg/cm² (ONE LAYER) | | | | | | |
|---|---|---|---|---|---|---|---|---|
| | | BLACK | COLOR | | | | | |
| | | REFERENCE | SAMPLE | SAMPLE | SAMPLE | SAMPLE | SAMPLE | COMPARISON |
| | | SAMPLE | 6 | 7 | 8 | 9 | 10 | SAMPLE B |
| OPTICAL ABSORPTANCEλ3 (%) | | 100 (λ1) | 38 | 50 | 82 | 90 | 98 | 100 |
| LIGHT | 0.45 | Δ | x | x | Δ | Δ | Δ | Δ |
| OUTPUT | 0.51 | Δ | x | x | Δ | Δ | Δ | Δ |
| J/cm² | 0.57 | O | x | Δ | ∘ | ∘ | ∘ | ∘ |
| | 0.63 | O | ∘ | ∘ | ∘ | ∘ | ∘ | ∘ |
| | 0.68 | O | ∘ | ∘ | ∘ | ∘ | ∘ | ∘ |
| | 0.80 | O | ∘ | ∘ | ∘ | ∘ | ∘ | ∘ |
| | 0.91 | O | ∘ | ∘ | ∘ | ∘ | ∘ | ∘ |
| | 1.02 | O | ∘ | ∘ | ∘ | ∘ | ∘ | ∘ |
| | 1.14 | O | ∘ | ∘ | ∘ | ∘ | ∘ | ∘ |
| | | | ATTACHED AMOUNT 1.2 mg/cm² (THREE LAMINATED LAYERS) | | | | | |
| | | | COLOR | | | | | |
| | | | SAMPLE | SAMPLE | SAMPLE | SAMPLE | SAMPLE | COMPARISON |
| | | | 6 | 7 | 8 | 9 | 10 | SAMPLE B |
| OPTICAL ABSORPTANCE λ3 (%) | | | 38 | 50 | 82 | 90 | 98 | 100 |
| | LIGHT | 0.45 | x | x | x | x | x | x |
| | OUTPUT | 0.51 | x | x | x | x | x | x |
| | J/cm² | 0.57 | x | x | x | x | x | x |
| | | 0.63 | x | x | x | x | x | x |
| | | 0.68 | x | Δ | Δ | Δ | x | x |
| | | 0.80 | Δ | ∘ | ∘ | ∘ | Δ | Δ |
| | | 0.91 | Δ | ∘ | ∘ | ∘ | Δ | Δ |
| | | 1.02 | ∘ | ∘ | ∘ | ∘ | ∘ | ∘ |
| | | 1.14 | ∘ | ∘ | ∘ | ∘ | ∘ | ∘ |

From the result shown in Table 4, it was confirmed that in both cases of the one color toner layer and the three color toner layers, by increasing the light output to some extent, a preferable fixing property can be obtained in each of the samples 6 to 10, and the comparison sample B in which the phthalocyanine compound is used as the infrared light absorbent, and the optical absorptance of the color toner is set to be lower than or equal to the optical absorptance of the black toner.

More specifically, as for the one color toner layer, it was confirmed that the samples 8 to 10, and the comparison sample B (optical absorptance is 82 to 100%) can be preferably fixed under the condition that the light output is 0.57 to 1.14 J/cm², and the samples 6 to 10, and the comparison sample B (optical absorptance is 38 to 100%) can be preferably fixed under the condition that the light output is 0.63 to 1.14 J/cm².

Meanwhile, as for the three color toner layers, it was confirmed that the samples 7 to 9 (optical absorptance is 50 to 90%) can be preferably fixed under the condition that the light output is 0.80 to 1.14 J/cm², and the samples 6 to 10, and the comparison sample B (optical absorptance is 38 to 100%) can be preferably fixed under the condition that the light output is 1.02 to 1.14 J/cm².

However, as for the one color toner layer and the three color toner layers in the sample 10 containing 4% by weight of infrared light absorbent, and the comparison sample B containing 6% by weight thereof, even when the fixing property is good (O), irregularities like foam were recognized on the toner surface under the condition of 1.02 to 1.14 J/cm². It is considered that this was caused because the toner surface temperature becomes too high and thermal decomposition is generated.

In addition, although a test for a case of the two color toner layers is also omitted in the working example 2, the result of the two color toner layers is considered to exist between the result of the one color toner layer and the result of the three color toner layers.

Thus, from the results of the working examples 1 and 2, it was found that as the common conditions to obtain the preferable fixing property and toner surface in the case of the one to three color toner layers, and to obtain the preferable fixing property in the case of the black toner, the samples 2 to 4 and 7 to 9 in which the optical absorptance is set to 50 to 90% are to be used, and the light output is to be set to 0.80 to 1.14 J/cm².

Furthermore, a cost of the color toner is decreased with the less the content of the infrared light absorbent, so that it is preferable to use the cyanine compound instead of using the phthalocyanine.

What is claimed is:

1. A color toner for optical fixing containing an infrared light absorbent and being compatible with an optical fusing device to irradiate an unfixed toner attached on a surface of a recording medium with infrared light to melt and fix the unfixed toner on the recording medium, wherein
an optical absorptance of the color toner is set to be lower than an optical absorptance of a black toner in a wavelength region of the infrared light emitted from the optical fusing device.

2. The color toner for optical fixing according to claim 1, wherein
the optical absorptance of the color toner is set to be 50 to 90% of the optical absorptance of the black toner.

3. The color toner for optical fixing according to claim 1, wherein
the infrared light absorbent is enclosed with a resin particle serving as a component material of the color toner.

4. The color toner for optical fixing according to claim 1, wherein
the infrared light absorbent is a cyanine compound.

5. An image forming apparatus comprising:
a photoconductor drum having a surface on which an electrostatic latent image is formed;
a charging device charging a surface of the photoconductor drum;
an exposure device forming an electrostatic latent image on the surface of the photoconductor drum;
a developing device having capacity to accommodate the color toner for optical fixing according to claim 1, and a black toner, and supplying the toner to the electrostatic latent image on the surface of the photoconductor drum to form a toner image;
a transferring device transferring the toner image on the surface of the photoconductor drum to a recording medium; and
an optical fusing device irradiating the toner image transferred to the recording medium with infrared light.

6. The image forming apparatus according to claim 5, wherein
the optical fusing device emits infrared laser light.

7. The image forming apparatus according to claim 6, wherein
the optical fusing device comprises a semiconductor laser as a light source.
